(19) United States
(12) Patent Application Publication
(10) Pub. No.: US 2006/0153753 A1
(43) Pub. Date: Jul. 13, 2006

(54) Method and device for regenerating a particulate filter for exhaust line, and adapted particulate filter

(76) Inventors: Sylvain Mauran, Espira de L'agly (FR); Driss Stitou, Nazaire/Roussillon (FR); Sandrine Guiguet, Petit-Noir (FR); Emmanuel Boudard, Bretonneux (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/533,105

(22) PCT Filed: Oct. 28, 2003
(86) PCT No.: PCT/FR03/03210

§ 371 Date: Nov. 3, 2005

(30) Foreign Application Priority Data
Oct. 29, 2002 (FR) 0213548

(51) Int. Cl. B01J 10/00; B01J 8/04

(52) U.S. Cl. 422/193

(57) ABSTRACT

The invention relates to a method of regenerating an exhaust line particle filter wherein particles lining the walls of the filter are heated to a temperature higher than their combustion temperature, which method is characterized in that: the heat necessary to heat said particles is produced by adding to a solid first compound present in a reactor a gaseous second compound adapted to combine with said first compound to form a solid third compound by way of an exothermic reaction, and the heat resulting from the combustion of said particles is used to regenerate said solid first compound and said second compound by way of an endothermic reaction that is the opposite of said exothermic reaction. The invention also relates to an exhaust line and a particle filter for implementing the above method.

The invention relates to the automotive industry. To be more precise, it relates to regenerating particle filters used on diesel engine exhaust lines of vehicles of recent design.

Diesel-engined automotive vehicles of recent design have their exhaust line equipped with particle filters (PF) to reduce emission of solid pollutants. Soot collects on the PF walls and must be eliminated regularly to prevent the PF clogging and to return it to its nominal efficiency. Also, clogging of the PF progressively creates a back-pressure that is harmful to proper operation of the engine. The soot may be eliminated by heating the filter to a temperature higher than the combustion temperature of the soot (which is normally around 550° C.) by means of the exhaust gas flowing therein. To this end, the most widespread technical solution consists in:

adding to the fuel, for example when filling the tank, an additive such as ceria whose function is to reduce the combustion temperature of the soot to around 450° C.; and

periodically post-injecting fuel into the exhaust line on the upstream side of the PF, which heats the exhaust gas to a temperature sufficient to ignite the soot (450° C. or higher).

The above technique has the following drawbacks.

Firstly, it consumes energy, since post-injection leads to increased fuel consumption.

Secondly, during PF regeneration phases, the combustion of the post-injected fuel is particularly unstable and requires conditions of engine load and fluid temperature that can be difficult to achieve under certain climatic or operating conditions. If combustion is incomplete or uncontrolled, it leads to the emission of pollutant gas and consumes oxygen, with the risk of defective combustion of the soot following post-injection of fuel. It is therefore possible for post-injection to have the effect opposite to that required, and good management of post-injection makes it necessary to find compromises. Management of post-injection has to be refined and controlled, and achieving this has proved to be particularly complex.

Another solution for PF regeneration is heating to a temperature higher than the soot combustion temperature by means of electrical heating elements. However, that solution is costly in terms of energy, as is heating the exhaust gas by electrical heating elements. Moreover, heating the filter causes thermal gradients within the filter which eventually accelerate its deterioration.

Moreover, the ceria used to reduce the soot combustion temperature constitutes an impurity in itself, tending to block the passages of the PF. This makes it necessary to remove and clean the filter about every 80 000 kilometers (km).

The object of the invention is to propose a method of regenerating a particle filter that is simple to use, effective, economic in terms of energy, and does not have the drawbacks associated with post-injection of fuel referred to above.

To this end, the invention consists in a method of regenerating a particle filter for an internal combustion engine exhaust line, wherein particles lining the walls of the filter are heated to a temperature higher than their combustion temperature, which method is characterized in that:

the heat necessary to heat said particles is produced by adding to a solid first compound present in a reactor a gaseous second compound adapted to combine with said first compound to form a solid third compound by way of an exothermic first reaction, and

the heat resulting from the combustion of said particles is used to regenerate said solid first compound present in said reactor and said gaseous second compound by way of an endothermic second reaction that is the opposite of said exothermic first reaction.

The heat to be imparted to the particles to heat them and the heat to be imparted to the solid third compound to regenerate the solid first compound can be transmitted through the walls of the particle filter or via the exhaust gas flowing along said exhaust line.

In a preferred but not exclusive embodiment of the invention, said solid first compound is lime (CaO) and said second compound is steam.

The invention also consists in an internal combustion engine exhaust line of the type including a particle filter and means for regenerating it adapted to heat particles lining the walls of the filter to a temperature greater than their combustion temperature, which exhaust line is characterized in that said means comprise:

a reactor containing a solid first compound;

an evaporator for vaporizing a second compound able to combine with said solid first compound to form a solid third compound by way of an exothermic reaction;

means for establishing communication between said evaporator and said reactor on command;

means for communicating to said particles the heat generated by combining said first and second compounds;

means for communicating to said solid third compound the reaction heat generated by the combustion of said particles so as to cause regeneration of said first and second compounds during said combustion;

means for collecting said second compound in gaseous form during said regeneration of the first and second compounds and for transmitting it to a condenser for liquefying it; and

means for establishing communication between said condenser and said evaporator on command.

A reactor containing the solid first compound may be integrated into the particle filter.

A reactor containing the solid first compound may be placed against the outside wall of the exhaust line.

Said means for communicating to said solid third compound the reaction heat generated by the combustion of said particles may include a heat pipe for collecting heat from the exhaust gas on the downstream side of the particle filter.

Said reactor containing said solid first compound may be placed inside or outside the exhaust line on the upstream side of the particle filter on the normal path of the exhaust gas and the means for communicating to said solid third compound the reaction heat generated by the combustion of said particles may include branch pipes and valves for modifying the path of the exhaust gas in such a manner as to place said reactor that is on the downstream side of the particle filter on the path of the exhaust gas during regeneration of the first and second compounds.

Said reactor containing said solid first compound may be placed inside or outside the exhaust line on the downstream side of the particle filter and may include a heat pipe for transmitting heat generated by combining said first and second compounds to the particle filter and/or to the exhaust gas on the upstream side of the particle filter.

The exhaust line may include means for detecting clogging of the particle filter and for triggering regeneration of said particle filter.

It may include means for detecting initiation of the reaction of combustion of the particles lining the filter and for triggering the establishing of communication between said reactor and said condenser.

The invention also consists in a particle filter for an internal combustion engine exhaust line, characterized in that it includes a reactor situated away from the path of the exhaust gas and containing a solid first compound able to react with a second compound by way of a reversible exothermic reaction in such manner as to heat the walls of said filter to a temperature greater than the combustion temperature of particles said filter is intended to capture.

A reactor may be placed around said filter and/or integrated into said filter.

Clearly, the invention is based on combining a particle filter (PF) and a thermochemical reactor capable of increasing the temperature of a heat source by means of a solid-gas reaction. The reactor is used to heat the PF or the exhaust gas to a temperature higher than the soot combustion temperature. To this end, a solid reagent X combines in the reactor with a gas G initially contained in partly liquid form in an evaporator by way of a reversible exothermic reaction X+G→XG+heat. This generation of heat increases the temperature of the PF or the exhaust gas sufficiently for combustion of the soot. Since that combustion is exothermic, it contributes wholly or in part to regenerating said first and second compounds by decomposing the solid third compound XG. The minimum temperature to which the compound XG must be heated during its decomposition is a function of the vapor pressure of the compound G obtained when communication is established between said reactor and said condenser, in which the compound G is recovered in the liquid state. The compound G in the liquid state is periodically sent to the evaporator and is then ready to participate in further regeneration of the PF.

The invention will be better understood on reading the following description, which is given with reference to the appended drawings, in which:

FIG. 1 is a diagram showing in longitudinal section the components of a portion of an exhaust line equipped with one embodiment of a device of the invention when idle;

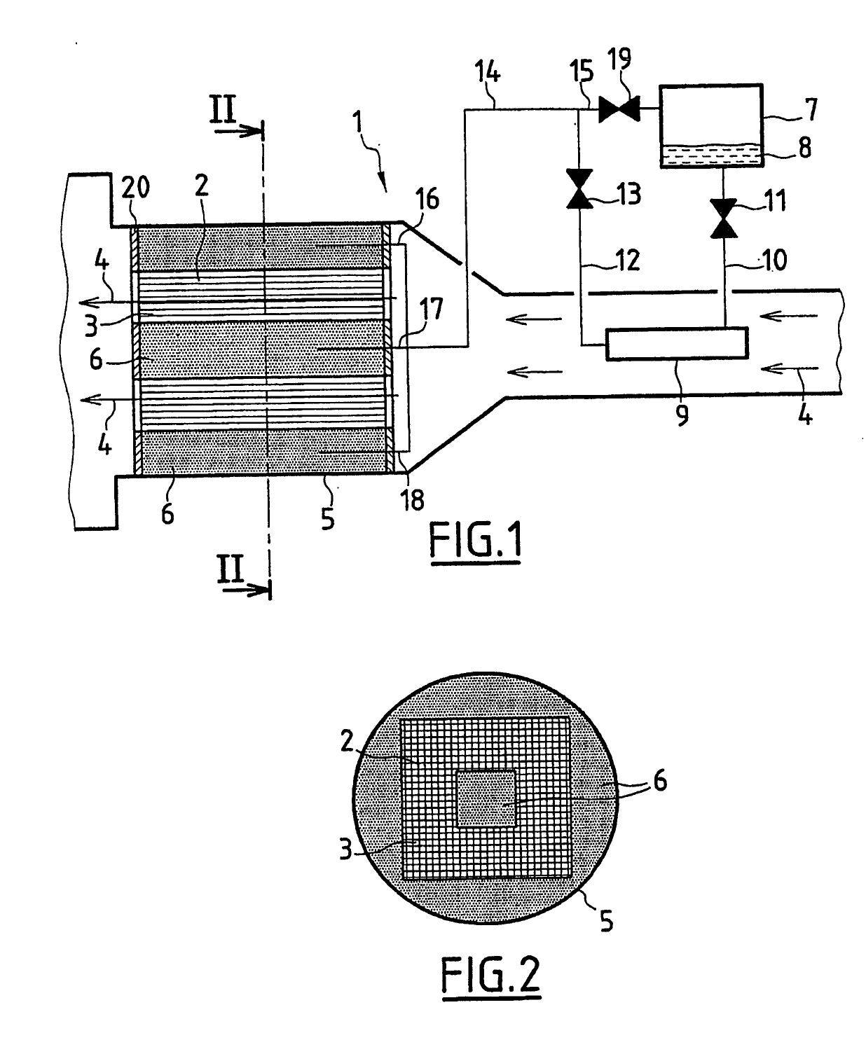

FIG. 2 shows a portion of the FIG. 1 exhaust line in cross section taken along the line II-II;

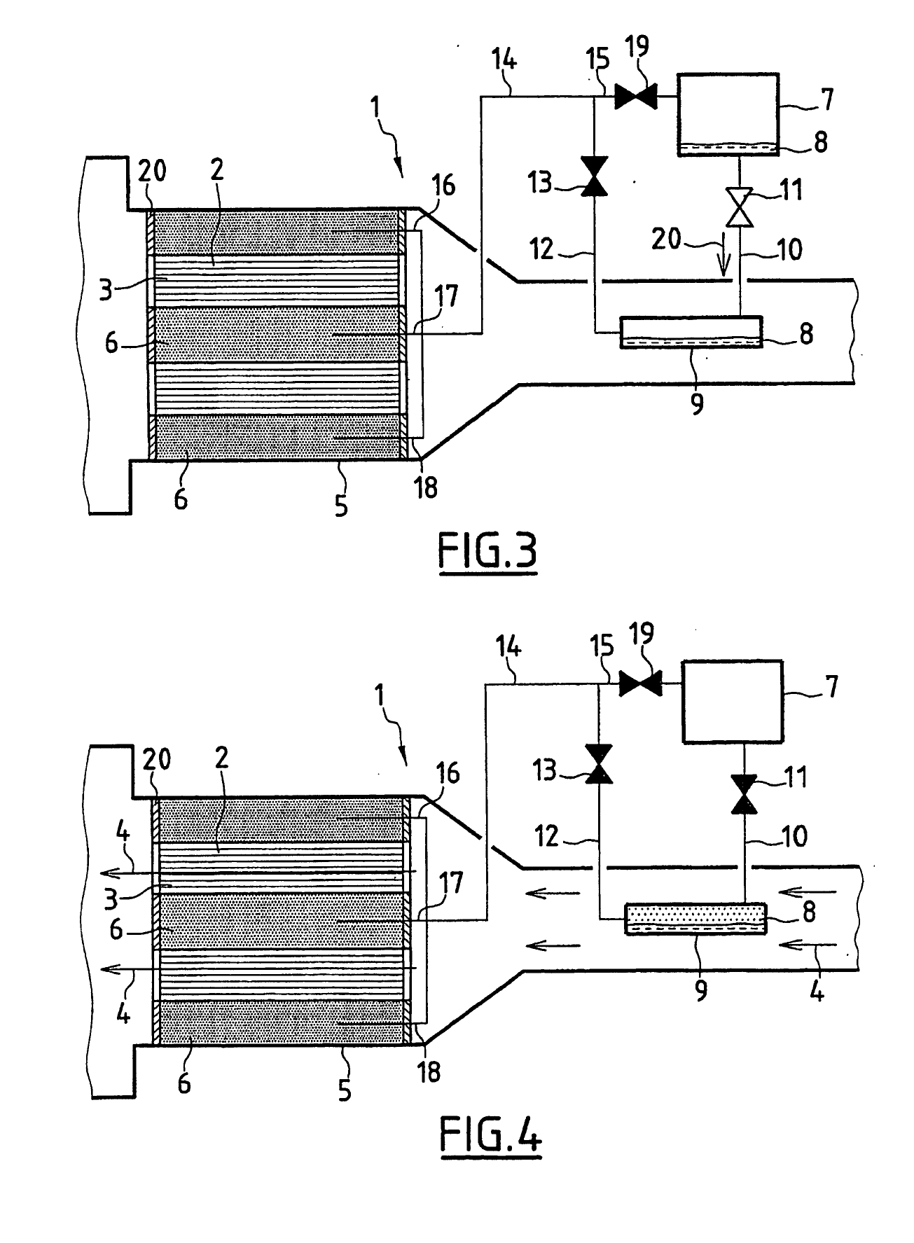

FIGS. 3 to 6 show the operation of this embodiment of the device of the invention in its successive configurations;

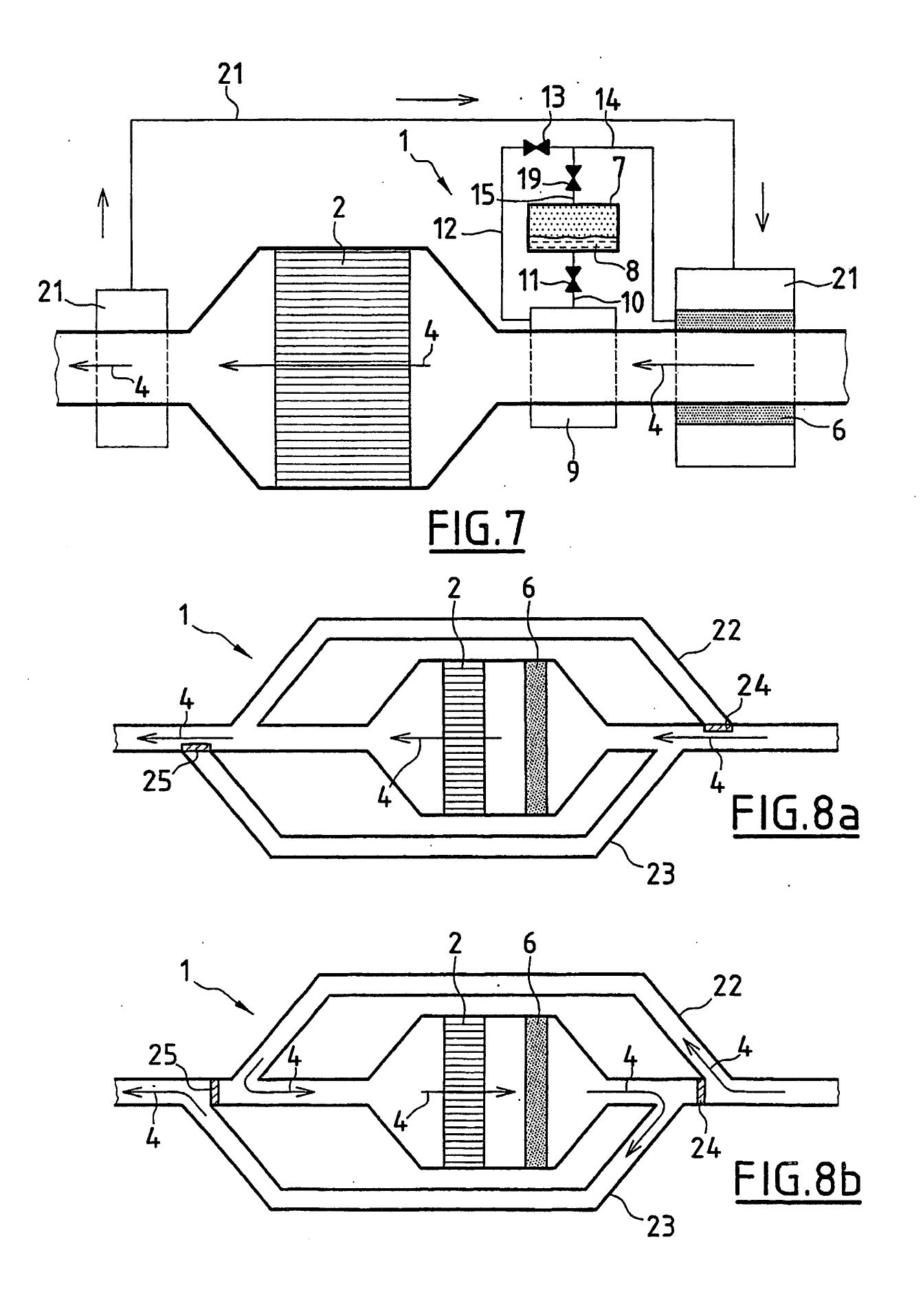

FIG. 7 shows a second embodiment of a device of the invention; and

FIGS. 8a, 8b show a third embodiment of a device of the invention.

A particle filter for a diesel engine exhaust line consists of a ceramic element having a multiplicity of passages, for example an element made of silicon carbide (SiC). Soot resulting from combustion of the fuel is retained on the walls of the passages. The filter can withstand high temperatures, of the order of 1200° C., encountered locally on its inside walls when the soot is combusted to regenerate the filter. As a general rule, regeneration is required every 400 km to 500 km, although this distance can obviously vary as a function of the quality of the fuel used, the conditions of use of the vehicle, and the adjustments of the engine.

The exhaust line 1 shown partly in FIG. 1 is equipped with a PF 2 of the above kind including a multiplicity of passages 3 through which exhaust gas to be cleansed of its solid pollutant particles flows, as shown by the arrow 4, this gas arriving from the upstream portion of the line 1 (that on the right-hand side in FIG. 1).

According to the invention, the portion 5 of the exhaust line in which the PF 2 is installed includes a reactor disposed around the PF 2, and also in place of the central region of the PF 2 (and thus integrated into the PF 2), the reactor containing a reagent 6 consisting of a solid first compound having the following properties under the relevant conditions of temperature and pressure:

at the usual temperature of the exhaust gas (which is generally of the order of 150-250° C.), the solid first compound is able to absorb a given second compound that is in the gaseous state at the same temperature, but that is able to condense under normal or readily obtainable conditions of temperature and pressure, said absorption reaction being strongly exothermic and therefore able to heat the soot coating the walls of the passages 3 of the PF 2 to a temperature higher than their combustion temperature, and

because of the effect of the heat generated by combustion of the soot, the solid first component is regenerated in its original state by the endothermic reaction that is the opposite of the previous reaction, said gaseous second compound being released in order to be condensed.

A preferred example of the solid first compound is lime (CaO), because is able to react with steam by the following reversible reaction:

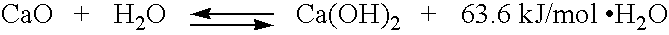

It is this combination CaO/H₂O that is considered by way of example in the remainder of the description, although this must not be regarded as limiting the invention.

According to the invention, the device for regenerating the PF 2 comprises:

a condenser 7 external to the line 1 and which, when the system is idle, contains water 8 in the liquid state;

an evaporator 9 inside the line 1, on the upstream side of the PF 2, and which can selectively communicate with the condenser 7 via a pipe 10 including a valve 11 that is closed when the system is idle;

a branch pipe 12 connected to the evaporator 9 and including a valve 13 that selectively allows steam present in the evaporator 9 when the device is operating to be directed onto the lime CaO 6 situated at the periphery and at the centre of the PF 2 and is closed when the system is idle; and

two branch pipes 14, 15 connected to the pipe 12 on the downstream side of the valve 13; the pipe 14 can feed steam onto the lime CaO 6, or extract it therefrom during regeneration steps, preferably by means of a multiplicity of branch connections 16, 17, 18, to guarantee as homogeneous a distribution of the water as may be desirable in the reaction area, as well as equally homogeneous extraction of water during steps of regenerating the lime CaO 6 in the reactor; the pipe 15 conveys steam extracted from the reaction area to the condenser 7; a valve 19 on the pipe 15 controls the entry of steam into the condenser 7.

When the installation is idle, it may be in the configuration represented in FIG. 1, with water 8 present in the condenser 7 in the liquid state and all the valves 11, 13, 19 closed (and thus shown black in FIG. 1).

If the installation is required to be operational quickly, the valve 11 is opened (see FIG. 3, in which the open valve 11 is shown white) and water 8 is sent to the evaporator 9 (arrow 20). This transfer can be effected by a pump or simply by gravity if the configuration of the invention allows this. Once the transfer has been completed, the valve 11 is closed and the water 8 present in the evaporator 9 is heated to the temperature of the exhaust gas flowing around the evaporator. The water 8 is advantageously transferred into the evaporator 9 when the vehicle is stopped, the temperatures of the condenser 7 and the evaporator 9 tending to equalize. This situation is symbolically represented in FIG. 3 by the lack of any arrows 4 representing the flow of exhaust gas.

The installation is in the state represented in FIG. 4 when the vehicle is moving. All the valves 11, 13, 19 are closed and all the water 8 is in the evaporator 9, in liquid-vapor equilibrium, and therefore at the saturation vapor pressure, for example 5 bar to 35 bar, depending on the temperature of the exhaust gas, (150° C. to 250° C.).

Regeneration of the PF can begin from the above state.

This operation can be started at the initiative of the driver or automatically. The triggering time can be determined systematically as a function of the distance traveled since the last regeneration cycle. Triggering can also be decided on because appropriate sensors indicate an abnormally high head loss of the exhaust gas between the upstream and downstream sides of the PF 2, indicating clogging of the passages 3 of the PF 2.

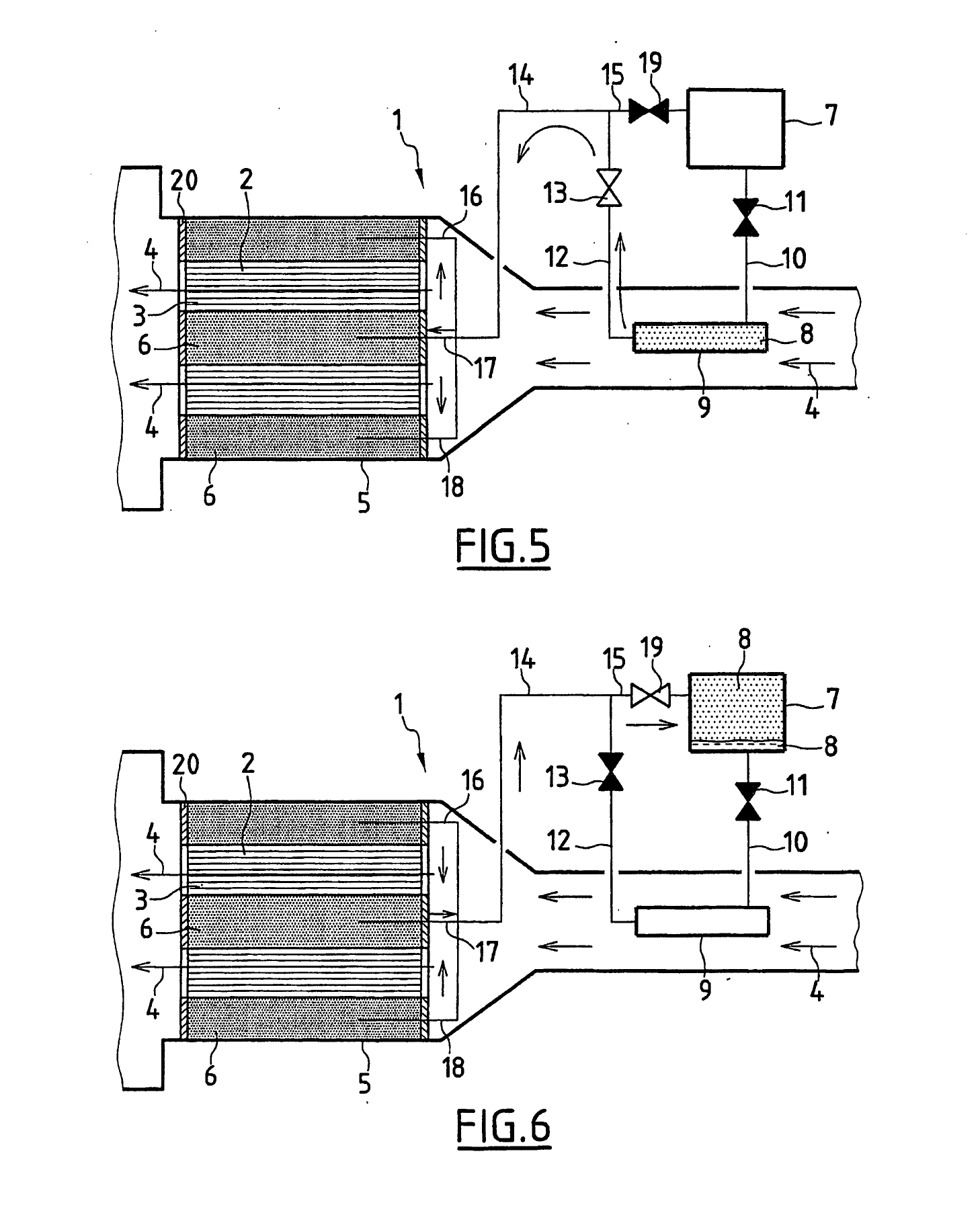

Once a regeneration operation has been decided on, the installation is placed in the configuration shown in FIG. 5. The valves 11, 19 remain closed and the valve 13 is opened, with the result that steam 8 is directed onto the lime CaO 6 and absorbed thereby to effect the exothermic reaction:
CaO+H₂O→Ca(OH)₂+ΔH

The heat generated is communicated to the soot deposited in the passages 3 via the walls of the PF 2, the parameters of the installation being chosen so that the soot is heated to a temperature higher than its combustion temperature, in order to initiate combustion. In particular, the steam pressure must be sufficient. In this way the passages 3 of the PF 2 are cleansed of the soot coating them.

Because the combustion of the soot is exothermic, it can heat the PF 2 to a temperature of 1000° C. or more. This heat is transmitted to the calcium hydroxide 6 surrounding it. However, this temperature rise is not essential for the system to operate, as explained above.

Combustion can be detected by measuring the exhaust gas temperature difference or the pressure difference between respective opposite sides of the PF 2. At this time the configuration of the installation is changed to that of FIG. 6, with the valves 11, 13 closed and the valve 19 open. Because of the heat from combustion of the soot, steam that is generated by the endothermic reaction that regenerates the lime CaO 6:
Ca(OH)₂→CaO+H₂O−ΔH
passes through the pipes 16, 17, 18, 14, 15 into the condenser 7, where it condenses. The condenser 7 may be cooled by an external flow of fluid to achieve this, but simple cooling by ambient air may be sufficient.

When the reactions to regenerate the PF 2 and the lime CaO 6 are completed (which can be detected by comparing the temperatures of the exhaust gas on the upstream and downstream sides of the PF 2 and finding that they have become very similar again), the valve 19 is closed and the installation returned to the idle state described above and represented in FIG. 1.

Alternatively, the idle state of the installation, during which the vehicle and its exhaust line 1 operate under normal conditions, may be the state represented in FIG. 4, in which water 8 is present in the evaporator 9 under liquid-vapor equilibrium.

The whole of the regeneration of the PF 2 between the start of admission of steam 8 into the CaO 6 and the returning of all the steam 8 to the condenser 7 can take approximately one minute, or even less.

Compared to existing PF regeneration installations, the installation of the invention has the very significant advantage of limiting, or even eliminating, input of external energy apart from the entirely negligible amount of energy needed to operate the valves 11, 13, 19 and the sensors for determining the favorable times for triggering the various steps of the cycle. This is possible because the chemical reactions employed are “self-maintaining”, as it were, the heat from the exothermic reaction of hydration of the lime CaO triggering the exothermic reaction of combustion of the soot, the reaction heat of which in turn triggers the endothermic reaction of dehydrating the hydroxide Ca(OH)₂.

In particular, post-injection of fuel is not necessarily useful for regenerating the PF 2. It is even possible, if the various characteristics of the installation are appropriate, to dispense entirely with the addition of ceria to the fuel, provided that the heat given off by hydration of the lime CaO 6 is sufficient to achieve a temperature sufficiently high to initiate combustion of the soot. The installation is then particularly economical to use.

It will also be noted that regeneration is effected without using materials that are hazardous to the environment and does not in itself produce any polluting compounds.

As the combination of the PF 2 and the reactor is placed in a casing 20 that is open only where it faces the components of the PF 2 and the passages for the pipes 16, 17, 18, the lime CaO 6 is not on the path of the exhaust gas and does not come into contact with them. It is therefore not poisoned by impurities present in the fuel (for example sulfur).

Mixing the lime CaO 6 with a material that is a good conductor of heat, such as expanded graphite, is recommended to improve heat transfer with the PF 2. This material also has the advantage of being porous and thus of allowing the steam to pass through the lime CaO 6.

The configuration of the PF 2 and its environment shown by way of example in FIGS. 1 to 6 is advantageous in that the PF 2 is heated both from the inside and from the outside by the lime CaO 6 during the hydration reaction, and conversely the lime 6 in the hydrated state is everywhere relatively close to the heat source represented by the PF 2 when heated during the combustion of soot. For these reasons, the efficiency of the heat transfers and the progress of the chemical reactions resulting therefrom can be optimized. However, it would remain within the spirit of the invention to dispose the lime CaO 6 only around the PF 2 or only at the centre of the PF 2. Conversely, a plurality of “rods” of lime CaO 6 could be disposed inside the PF 2 instead of a single one as in the example shown. Generally speaking, disposing the lime CaO 6 in multiple locations of the PF 2 minimizes temperature gradients inside the PF 2 and therefore the mechanical stresses to which it is subjected.

Another alternative to the configuration shown would be to move the evaporator 9 to the downstream side of the PF 2 or out of the exhaust line 1 and into contact with its outside wall. This avoids the possibility of disturbing the gas flows inside the PF 2.

Integrating the reactor containing the lime CaO 6 with the PF 2 itself and/or its immediate environment has the advantages as stated above, but is not without drawbacks, however. The heat produced by the various chemical reactions is consumed in part to heat the walls of the PF 2 and not to heat the soot or the hydrated lime 6 directly. Also, some of this heat is evacuated by the exhaust gas flow and is not recovered by the soot or the hydrated lime 6 either. Obtaining satisfactory results may therefore lead to increasing the external dimensions of the exhaust line significantly relative to what is usual. Also, it is necessary to redesign completely the exhaust line in the area of the PF 2, and the necessary modifications may not be suitable for an existing line.

To overcome these drawbacks, the solution represented in FIG. 7 may be envisaged, where the entire PF 2 regeneration reactor and its ancillaries are installed outside the exhaust line (in FIG. 7 components with exactly the same function as those represented in FIGS. 1 to 6 are designated by the same reference numbers).

In this variant, the reactor containing the lime CaO 6 is disposed outside and around the exhaust line 1, on the upstream side of the PF 2. The evaporator 9 is also disposed outside and around the exhaust line 9, between the PF 2 and the reactor containing the lime CaO 6. Heat transfer between the exhaust gas and these two devices is therefore effected through the wall of the exhaust line 1. A heat pipe 21 or any other functionally equivalent device transmits heat from the exhaust gas on the downstream side of the PF 2 to the reactor containing the lime CaO 6 on the upstream side of the PF 2.

When the decision to regenerate the PF 2 has been taken, the water contained in the evaporator 9 is fed in the form of steam into the lime CaO 6 via the pipes 12, 14, the valve 13 being the only open valve, and the reaction heat then heats the exhaust gas to a temperature higher than the soot combustion temperature. The combustion of the soot heats the exhaust gas, from which heat is recovered by the heat pipe 21, and the fluid therein transfers the heat to the hydrated lime 6 in order to regenerate the lime CaO. This is reflected in the sending of steam into the condenser 7, the valve 19 being the only open valve. After regeneration, the heat-exchange fluid in the heat pipe 21 returns to the downstream portion thereof.

In order to be installed on an existing exhaust line, this variant requires only sufficient free space in the environment of the PF 2 to install the reactor containing the lime CaO 6, the evaporator 9, the condenser 7, and the heat pipe 21. Other advantages are that the exhaust gas heated on the upstream side of the PF 2 enters directly into contact with the soot without requiring the PF 2 to be preheated and that the heating of the PF 2 after combustion of the soot is substantially homogeneous throughout its volume, which induces lower stresses in the material of the PF 2.

It is clear from the above description that to regenerate the PF 2 the reactor containing the lime CaO 6 must be on the upstream side of the PF 2, on the path of the exhaust gas, if it is not integrated into PF 2 itself. However, during combustion of the soot, it would be preferable for the reactor containing the hydrated lime 6 that is to be regenerated to be on the downstream side of the PF 2, in order to be regenerated directly by the exhaust gas heated by the combustion of the soot. This can be achieved by associating the exhaust line with a device for reversing the direction of flow of the exhaust gas through the PF 2 between the reaction step and the step of regenerating the lime CaO 6.

This can be achieved by means of the installation shown in FIGS. 8a, 8b. A PF 2 is inserted into the exhaust line 1, together with a reactor containing lime CaO 6, separate from the PF 2, and through which the exhaust gas can flow via appropriate perforations or pores. The reactor 6 is on the upstream side of the PF 2 on the normal path of the exhaust gas. The installation also includes an evaporator, a condenser, and the pipes and valves necessary for the operation of the reactor, which are similar to those described for the above-described variants of the invention and are not shown in FIGS. 8a, 8b. The line 1 also includes two branch pipes 22, 23 enabling the gas not to pass directly through the reactor 6 and the PF 2, and two valves 24, 25 controlling routing of the exhaust gas either directly to the reactor 6 and the PF 2, or else into the branch pipes 22, 23.

When the exhaust line 1 is operating normally, the valves 24, 25 isolate the branch pipes 22, 23 from the normal path of the exhaust gas, which gas therefore passes successively through the reactor containing lime CaO 6 and the PF 2 (see FIG. 8a).

When a cycle of regenerating the PF 2 is started, the valves 24, 25 remain in their preceding position and steam is directed onto the lime CaO 6 from the evaporator (not shown), to cause the reaction of hydrating the lime CaO 6, leading to heating of the exhaust gas before it passes through the PF 2 and to starting combustion of the soot in the PF 2.

Once combustion of the soot has started and has been detected, the valves 24, 25 are operated so that the exhaust gas passes first through the first branch pipe 22, then through the PF 2, in which it is heated by the combustion of the soot, then through the reactor containing the lime 6 in the hydrated state, so as to dehydrate it, and then through the second branch pipe 23, so as to be finally returned to the downstream portion of the exhaust line 1.

When regeneration of the lime CaO 6 is completed, the valves 24, 25 are returned to their original position and the exhaust line 1 begins to operate under normal conditions again.

In this configuration, it is possible for the exhaust gas to entrain particles of soot onto the casing of the reactor in which the lime 6 is being dehydrated. Combustion of that soot is then completed as close as possible to the tubes containing the solid calcium oxide or hydroxide, which encourages efficient transfer of heat.

In the example described and shown in FIGS. 8a, 8b, the reactor containing lime CaO 6 is placed inside the exhaust line 1, but it would be possible to place it around the line 1, as in the FIG. 7 example.

The invention is not limited to the examples described and shown. In particular, it would be possible to combine different variants of the invention, in particular to place reactors containing lime CaO 6 both inside and outside the PF 2, and generally inside and outside the exhaust line 1.

Another variant would have the reactor 6 containing the solid first compound inside or outside the exhaust line 1 on the downstream side of the PF 2 and transmit heat generated by the combination of the solid first compound and the gaseous second compound with the particles of soot directly to the PF 2 and/or to the exhaust gas on the upstream side of the PF 2, by means of a heat pipe.

The invention has a preferred application to diesel engine exhaust lines, but may be applied to the exhaust line of any type of internal combustion engine for which it might be deemed necessary to use a particle filter.

1. A method of regenerating a particle filter for an internal combustion engine exhaust line, wherein:
particles lining the walls of the filter are heated to a temperature higher than their combustion temperature,
the heat necessary to heat said particles is produced by adding to a solid first compound present in a reactor a gaseous second compound adapted to combine with said first compound to form a solid third compound by way of an exothermic first reaction, and
the heat resulting from the combustion of said particles is used to regenerate said solid first compound present in said reactor and said gaseous second compound by way of an endothermic second reaction that is the opposite of said exothermic first reaction.

2. A method according to claim 1, wherein the heat necessary to heat the particles is transmitted to them and the heat necessary to regenerate the solid first compound is transmitted to the solid third compound through the walls of the particle filter.

3. A method according to claim 1, wherein the heat necessary to heat the particles is transmitted to them and the heat necessary to regenerate the solid first compound is transmitted to the solid third compound by means of the exhaust gas passing through said exhaust line.

4. A method according to claim 1, wherein said solid first compound is lime CaO and said second compound is steam.

5. An internal combustion engine exhaust line, of the type including a particle filter and means for regenerating it, adapted to heat particles lining the walls of the filter to a temperature greater than their combustion temperature, wherein said means comprise:
a reactor containing a solid first compound;
an evaporator for vaporizing a second compound able to combine with said solid first compound to form a solid third compound by way of an exothermic reaction;
means for establishing communication between said evaporator and said reactor on command;
means for communicating to said particles the heat generated by combining said first and second compounds;
means for communicating to said solid third compound the reaction heat generated by the combustion of said particles so as to cause regeneration of said first and second compounds during said combustion;
means for collecting said second compound in gaseous form during said regeneration of the first and second compounds and for transmitting it to a condenser for liquefying it; and
means for establishing communication between said condenser and said evaporator on command.

6. An exhaust line according to claim 5, wherein a reactor containing the solid first compound is integrated into the particle filter.

7. An exhaust line according to claim 5, wherein a reactor containing the solid first compound is placed against the outside wall of the exhaust line.

8. An exhaust line according to claim 7, wherein said means for communicating to said solid third compound the reaction heat generated by the combustion of said particles include a heat pipe for collecting heat from the exhaust gas on the downstream side of the particle filter.

9. An exhaust line according to claim 5, wherein said reactor containing said solid first compound is placed inside or outside the exhaust line on the upstream side of the particle filter on the normal path of the exhaust gas, and the means for communicating to said solid third compound the reaction heat generated by the combustion of said particles include branch pipes and valves for modifying the path of the exhaust gas in such a manner as to place said reactor that is on the downstream side of the particle filter on the path of the exhaust gas during regeneration of the first and second compounds.

10. An exhaust line according to claim 5, wherein said reactor containing said solid first compound is placed inside or outside the exhaust line on the downstream side of the particle filter and it includes a heat pipe for transmitting heat generated by the combination of said first and second compounds to the particle filter and/or to the exhaust gas on the upstream side of the particle filter.

11. An exhaust line according to claim 5, including means for detecting clogging of the particle filter and for triggering regeneration of said particle filter.

12. An exhaust line according to claim 5, including means for detecting initiation of the reaction of combustion of the particles lining the filter and for triggering the establishing of communication between said reactor and said condenser.

13. A particle filter for an internal combustion engine exhaust line, the particle filter including a reactor situated away from the path of the exhaust gas and containing a solid first compound able to react with a second compound by way of a reversible exothermic reaction in such manner as to heat the walls of said filter to a temperature greater than the combustion temperature of particles said filter is intended to capture.

14. A particle filter according to claim 13, wherein a reactor is placed around said filter.

15. A particle filter according to claim 13, wherein a reactor is integrated into said filter.
